(19) United States
(12) Patent Application Publication
(10) Pub. No.: US 2005/0164542 A1
(43) Pub. Date: Jul. 28, 2005

(54) Connector with high performance transmission effect

(76) Inventor: Sung Chiang Wu, Taipei Hsien (TW)

Correspondence Address: SUNG CHIANG WU, 235 Chung-Ho, P.O. BOX 10-69, Taipei, TW

(21) Appl. No.: 10/764,870

(22) Filed: Jan. 27, 2004

(51) Int. Cl. H01R 4/24

(52) U.S. Cl. 439/387

(57) ABSTRACT

A connector comprises an upper cover having a plurality of holes; each of two sides of the upper cover having a respective guide hole and a respective metal retaining elastomer; a top of the upper cover having at least one plastic injection holes; a middle cover having a plurality of via holes for positioning the wires of terminals to the holes of the upper cover; a body being located with a plurality of terminals; the terminals being inserted into the holes of the upper cover through the via holes of the middle cover; the terminals piercing through the wires so as to conduct the wires and the terminals; each of two sides of the body having a respective hook which is inserted into a respective one of the guide holes so as to buckle a respective one of the metal retaining elastomer. Adhesive is filled into the plastic injection holes.

### FIELD OF THE INVENTION

The present invention relates to connectors, and particular to a connector has a novel terminal structure.

### BACKGROUND OF THE INVENTION

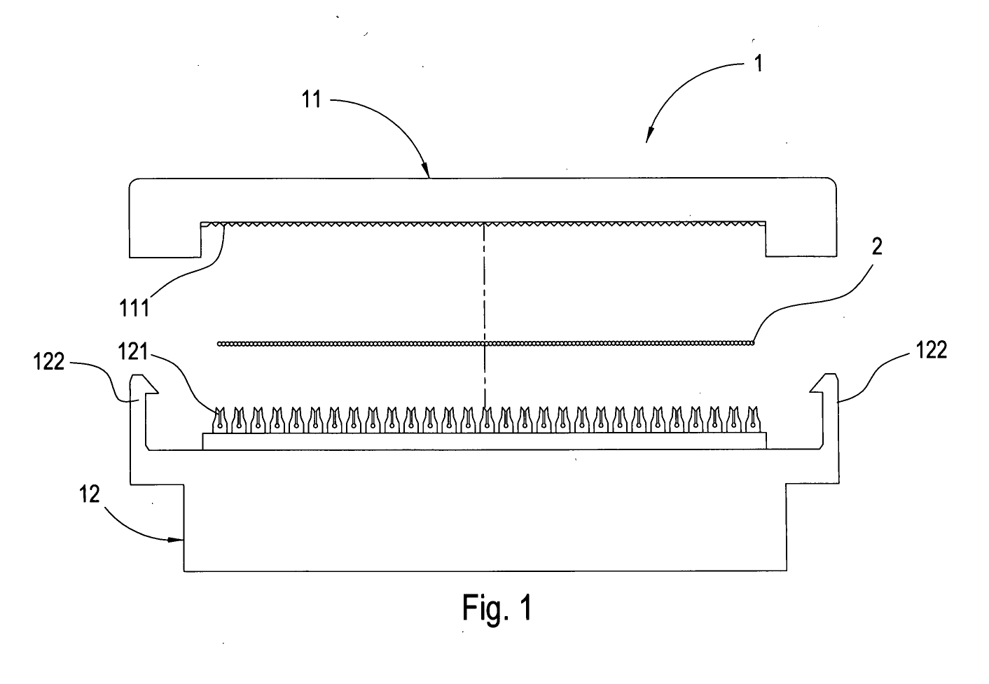

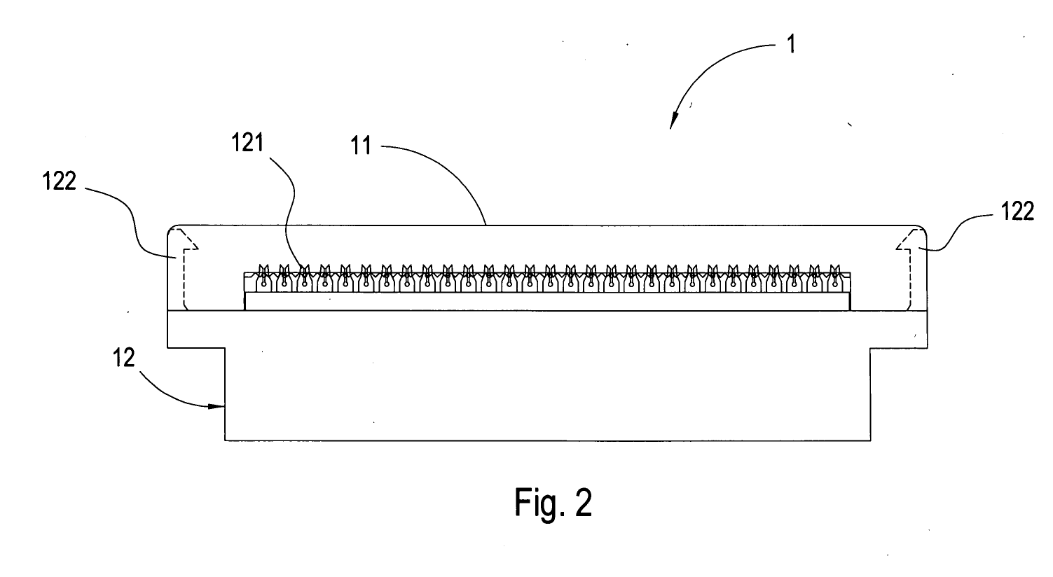

With reference to FIGS. 1 and 2, the exploded schematic view and schematic perspective view of the prior art connector are illustrated. The connector 1 is formed by an upper cover 11 and a body 12. Wires are arranged in the slots 111 of the upper cover 11. Then a body 12 having terminals 121 is pressed into the upper cover 11 so that the terminals 121 will pierce the wires 2 and thus the terminals are conducted to the wires 2. However, the upper cover 11 and the body 12 are not sealed completely. Only the upper cover 11 covers the tips of the terminals so that parts of the terminals 12 expose in air. The hooks at two sides of the body 12 are placed into the guide grooves at two sides of the upper cover so as to form a connector.

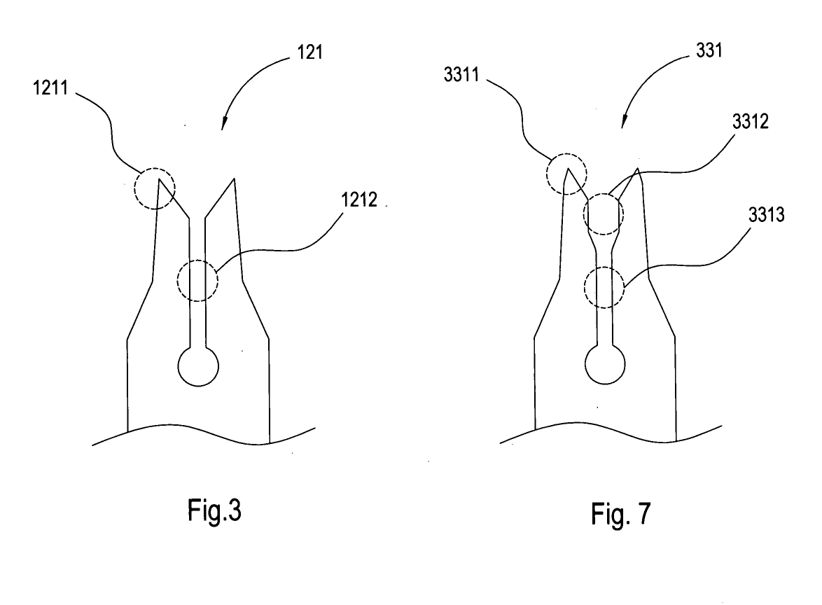

With reference to FIG. 3, the prior art terminals are illustrated. It is illustrated that the terminals 121 of the prior art has an opening with straight two sides. The tips 1211 of the terminal are used to pierce PVC covers. The lower portion 1211 has two parallel sides for clamping the copper silks within the PVC cover. The backside of the terminal has no function of fixing the wires.

Above prior arts have the following disadvantages.

When the body is pressed into the upper cover and the PVC covers break, the wires are not steadily positioned so that short circuit will occur and thus, it is possible that only one side is in contact with the terminal or some copper silks are cut. Thereby, it is unstable in high frequency transmission.

The plastic guide grooves and the hooks between the upper cover and the body are not fixed well, thereby, a larger error generates so that the structure is not stable.

Moreover, the exposed terminals will act like antennas. This further deteriorates the signal transmission in high frequency.

The slot of each terminal has two parallel sides which gives a pressure to the copper silks. In combination, the copper silks cannot be rearranged so as to fit the gap of the slot. Thereby, the copper silks will break possibly.

### SUMMARY OF THE INVENTION

Accordingly, the primary object of the present invention is to provide a connector, wherein the terminals are guided by the via holes so as to be connected to the upper cover. Thereby, the terminals can be correctly in contact with the wires. This is beneficial in high frequency transmission.

Another object of the present invention is to provide a connector, wherein when the upper cover is combined to the body, by the metal retaining elastomers and stainless hooks at two sides of the upper cover, the upper cover, middle cover and body are combined as an integral body. This way has a preferred effect and a small error.

Another object of the present invention is to provide a connector, wherein connector comprises an upper cover, a middle cover and a body. Adhesive is filled into the connector from the plastic injection holes at an upper side of the upper cover so that a part of each terminal is enclosed by the adhesive to delete electromagnetic interference. Thereby, the high frequency transmission has a preferred stability.

A further object of the present invention is to provide a connector, wherein an oblique slit at the terminal can fix the PVC cover. The middle section can buffer the expansion of the copper silks within the PCV cover so that the terminals will not expand by the PVC or the copper silks. Thereby, a preferred conduction is formed.

A still object of the present invention is to provide a connector, wherein the PVC cover is finally guided into the lower section of the slot of the terminal. The edges at the lower section are inactive so as not to cut the copper silks. Thereby, a complete contact and conduction can be complete.

To achieve above objects, the present invention provides a connector. The connector comprises an upper cover having a plurality of holes; each of two sides of the upper cover having a respective guide hole and a respective metal retaining elastomer; a top of the upper cover having at least one plastic injection holes; a middle cover having a plurality of via holes for positioning the wires of terminals to the holes of the upper cover; a body being located with a plurality of terminals; the terminals being inserted into the holes of the upper cover through the via holes of the middle cover; the terminals piercing through the wires so as to conduct the wires and the terminals; each of two sides of the body having a respective hook which is inserted into a respective one of the guide holes so as to buckle a respective one of the metal retaining elastomer. Adhesive is filled into the plastic injection holes for fixing the upper cover, middle cover and body and encloses the terminals so as to isolate part of the terminals.

The various objects and advantages of the present invention will be more readily understood from the following detailed description when read in conjunction with the appended drawing.

FIG. 1 is an exploded schematic view of a prior art connector of the present invention.

FIG. 2 is a schematic perspective view of the prior art connector.

FIG. 3 is a schematic view of the prior art terminal.

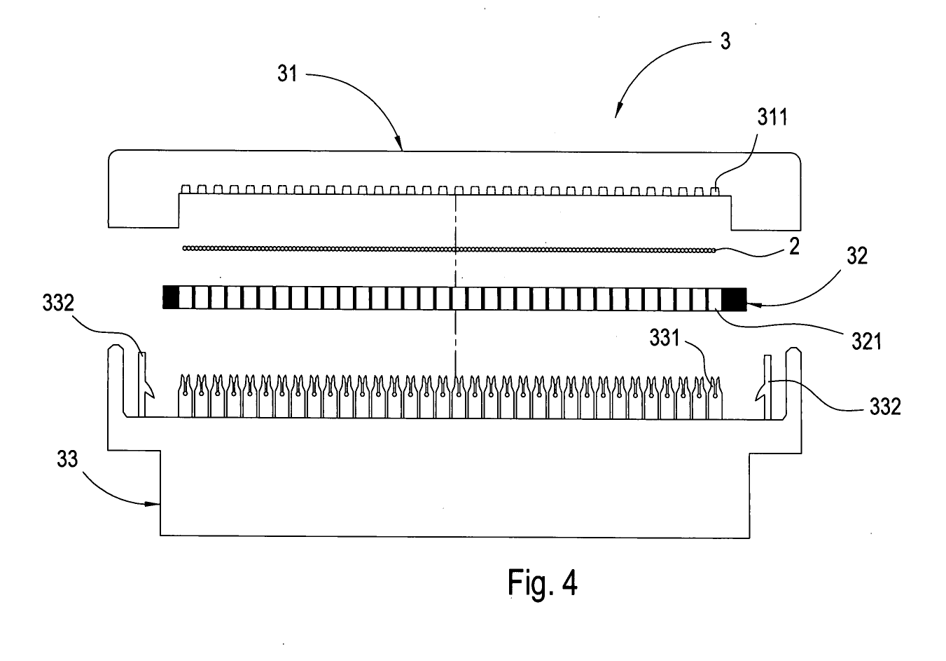

FIG. 4 is an exploded perspective view of the prior art connector.

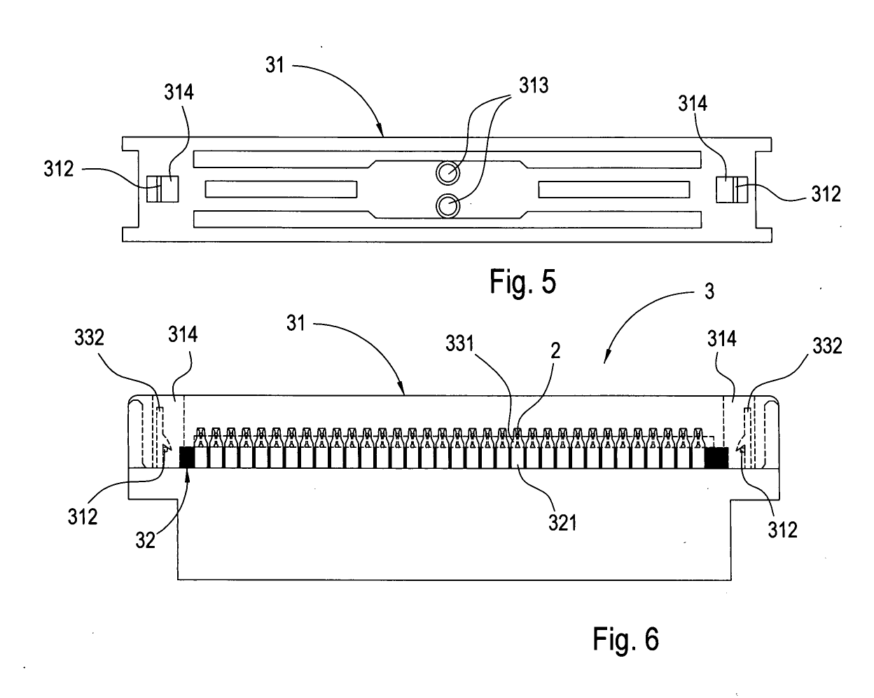

FIG. 5 is a top view of the connector according to the present invention.

FIG. 6 is a schematic perspective view of the prior art connector.

FIG. 7 is a schematic view of the terminal of the present invention.

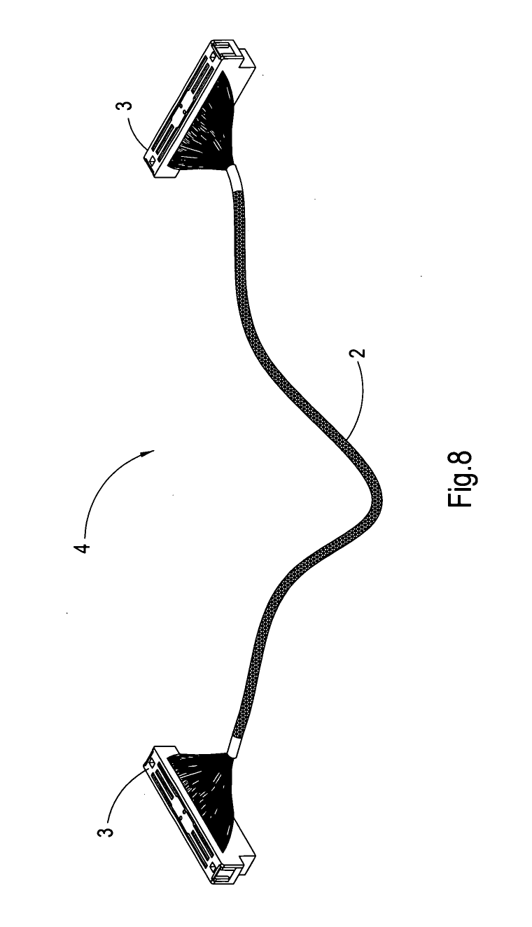

FIG. 8 is a schematic view of the connector of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

Referring to FIGS. 4, 5 and 6, the exploded schematic view, top view, and schematic perspective view of the connector of the present invention is illustrated. The connector 3 of the present invention comprises an upper cover 31, a middle cover 32 and a body 33.

The upper cover 31 has a plurality of holes 311. Each of two sides of the upper cover 31 has a respective guide hole 314 and a respective metal retaining elastomer 312. A top of the upper cover 31 has at least one plastic injection hole 313 (in the drawing, two plastic injection holes are illustrated).

The middle cover 32 has a plurality of via holes 321 for positioning the wires 2 of terminals to the holes 311 of the upper cover 31.

The body 33 are located with a plurality of terminals 331. The terminals 331 are inserted into the holes 311 of the upper cover 31 through the via holes 321 of the middle cover 32. The terminals 331 pierce through the wires 2 so as to conduct the wires and the terminals. Each of two sides of the body 33 has a respective hook 332 which is inserted into a respective one of the guide holes 314 so as to buckle a respective one of the metal retaining elastomer 312.

Adhesive is filled into the plastic injection holes 313 are fixed the upper cover 31, middle cover 32 and body 33 and encloses the terminals 331 so as to isolate part of the terminals to release from electromagnetic interference. Thereby, in high frequency signal transmission, the present invention provide a preferred stability.

With reference to FIG. 7, the terminal structure of the present invention is illustrated. Each terminal 331 has a slot having a shape like a spear. Each terminal has two tips 3311 at the top end thereof for cutting a PVC cover of a respective one of the wires. A middle section 3312 of the slot has a pair of parallel sides for tearing PVC cover so as to rearrange the copper silks within the PVC cover and buffer the extension of the wire so that the slot will not be expanded by the PVC cover and the core copper wire within the PVC cover so that the contact pressures is steady and electric conduction is retained. Then the wire enters into the lower section 3313. Edge of the lower section 3313 is inactive so that the copper silks will not be cut. Thus, the copper silks are completely in contact with the terminal and electric power is conductive. A backside of the terminal is formed with oblique slits for fixing the PVC cover.

With reference to FIG. 8, a schematic view of the present invention is illustrated. It is illustrated that the connector 3 of the present invention can be combined with an electric wire 2 so as to be as a connector means 4.

Advantages of the present invention will be described herein. The terminals are guided by the via holes so as to be connected to the upper cover. Thereby, the terminals can be correctly in contact with the wires. This is beneficial in high frequency transmission.

In the present invention, when the upper cover is combined to the body, by the metal retaining elastomers and stainless hooks at two sides of the upper cover, the upper cover, middle cover and body are combined as an integral body. This way has a preferred effect and a small error.

The connector of the present invention comprises an upper cover, a middle cover and a body. Adhesive is filled into the connector from the plastic injection holes at an upper side of the upper cover so that a part of each terminal is enclosed by the adhesive to delete electromagnetic interference. Thereby, the high frequency transmission has a preferred stability.

In the present invention, the oblique slit at the terminal can fix the PVC cover. The middle section can buffer the expansion of the copper silks within the PCV cover so that the terminals will not expand by the PVC or the copper silks. Thereby, a preferred conduction is formed.

The PVC cover is finally guided into the lower section of the slot of the terminal. The edges at the lower section are inactive so as not to cut the copper silks. Thereby, a complete contact and conduction can be complete.

In the present invention, a cross section view of each terminal is smaller than the conventional one so that it is stability in impedance match.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A connector comprising:
an upper cover having a plurality of holes; each of two sides of the upper cover having a respective guide hole and a respective metal retaining elastomer; a top of the upper cover having at least one plastic injection holes;
a middle cover having a plurality of via holes for positioning a plurality of wires to the holes of the upper cover;
a body being located with a plurality of terminals; the terminals being inserted into the holes of the upper cover through the via holes of the middle cover; the terminals piercing through the wires so as to conduct the wires and the terminals; each of two sides of the body having a respective hook which is inserted into a respective one of the guide holes so as to buckle a respective one of the metal retaining elastomer;
wherein adhesive is filled into the plastic injection holes for fixing the upper cover, middle cover and body and encloses the terminals so as to isolate part of the terminals.

2. The connector as claimed in claim 1, wherein each terminal has a slot having a spear shape; the slot comprises:
two tips at a top end of the slot for cutting the PVC cover of a respective one of the wires as the PVC enters into the slot;
a middle section of the slot having a pair of parallel sides for tearing cover so as to rearrange the copper silks within the PVC cover and buffer the extension of the wire so that the slot will not be expanded by the PVC cover and the core copper wire within the PVC cover, and thus the contact pressures is steady and electric conduction is retained;
a lower section of the slot; edges of the lower section being inactive so that the copper silks will not be cut when the wire is finally located in within the slot; thus, the copper silks being completely in contact with the terminal and electric power is conductive.

3. The connector as claimed in claim 1, wherein a back side of the terminal is formed with oblique slits for fixing the PVC cover.
